(19) United States
(12) Patent Application Publication
(10) Pub. No.: US 2002/0099615 A1
(43) Pub. Date: Jul. 25, 2002

(54) Method and system for configuring instrument transformers

(76) Inventors: Diane Christine Mobley, Raleigh, NC (US); Wayne Rautio, Nottingham, NH (US); Susan Gauld Montross, Center Barnstead, NH (US); Michael A. Motley, Simsbury, CT (US); Odunze C. Onyeberechi, Saratoga Springs, NY (US); Alex Lombardi, Marlborough, CT (US); David H. Merritt, Avon, CT (US)

Correspondence Address: John S. Beulick, Armstrong Teasdale LLP, Suite 2600, One Metropolitan Sq., St. Louis, MO, 63102, US

(21) Appl. No.: 09/767,281

(22) Filed: Jan. 23, 2001

(51) Int. Cl. G06F 17/60

(52) U.S. Cl. 705/26

(57) ABSTRACT

A network-based method for configuring instrument transformers includes receiving instrument transformer specification information from a user and using a server to compare the received specification information with pre-stored information. The method also includes selecting at least one instrument transformer that matches the received specification information and displaying to the user information related to the instrument transformer. A network-based method also provides for selection of a various accessories for the selected instrument transformer.

### BACKGROUND OF THE INVENTION

This invention relates generally to computer network-based systems and more particularly to a network-based method and system for configuring instrument transformers.

Instrument transformers are used in electric equipment and machinery, but identifying a correct instrument transformer for a specific application is not always an easy task. Many parameters should be considered, and each combination of parameters could demand a specific product for optimum performance.

Therefore, it would be desirable to quickly determine a proper product that should be used for different combinations of parameters. In addition, it would be desirable to determine if a particular product provides inadequate performance for equipment, machinery, or a facility.

### BRIEF SUMMARY OF THE INVENTION

In an exemplary embodiment, an instrument transformer selection system allows users to select the most appropriate instrument transformer for their application needs over the Internet. The system guides a web user to answer several pre-arranged questions interactively about the product attributes and then uses those inputs to direct the user to a uniquely configured product having a specific catalog number. If the user's input combination results in an invalid configuration, the user receives messaging to guide the user to a valid alternative. The system allows both experienced and novice users to place orders directly for instrument transformers through use of the Internet.

The network-based method for selecting a correct instrument transformer includes receiving product specification information from a user and comparing the received product specification information with pre-stored instrument transformer information. If at least one instrument transformer matches the received user criteria for the instrument transformer, the pre-stored instrument transformer information is downloaded for communication to the user.

The product information may include, for example, features of the product and accessories of the product. The method further includes validating configuration compatibility based on product information data and features of the product to determine whether a resulting product is capable of desired performance for a set of given product parameters.

### BRIEF DESCRIPTION OF THE DRAWINGS

FIG. 1 is a block diagram of a system in accordance with one embodiment of the present invention;

FIG. 2 is an expanded version block diagram of an exemplary embodiment of a server architecture of an alternative system;

FIG. 3 is a flow diagram of a network-based method for configuring instrument transformers;

FIG. 4 is an exemplary embodiment of an instrument transformer—main page;

FIG. 5 is an exemplary embodiment of an indoor current instrument transformer—application information page;

FIG. 6 is an exemplary embodiment of a second indoor current instrument transformer—application information page;

FIG. 7 is an exemplary embodiment of an indoor current instrument transformer—selector page;

FIG. 8 is an exemplary embodiment of an outdoor current instrument transformer—application information page;

FIG. 9 is an exemplary embodiment of an outdoor current instrument transformer—rating and construction page;

FIG. 10 is an exemplary embodiment of an outdoor current instrument transformer—selector page;

FIG. 11 is an exemplary embodiment of an indoor voltage instrument transformer—application information page;

FIG. 12 is an exemplary embodiment of an indoor voltage instrument transformer—rating and construction page;

FIG. 13 is an exemplary embodiment of an indoor voltage instrument transformer—selector page;

FIG. 14 is an exemplary embodiment of an outdoor voltage instrument transformer—application information page;

FIG. 15 is an exemplary embodiment of an outdoor voltage instrument transformer—rating and construction page;

FIG. 16 is an exemplary embodiment of an outdoor voltage instrument transformer—selector page;

FIG. 17 is an exemplary embodiment of an instrument transformer—cross-reference page; and

FIG. 18 is an exemplary embodiment of a bill of material page.

### DETAILED DESCRIPTION OF THE INVENTION

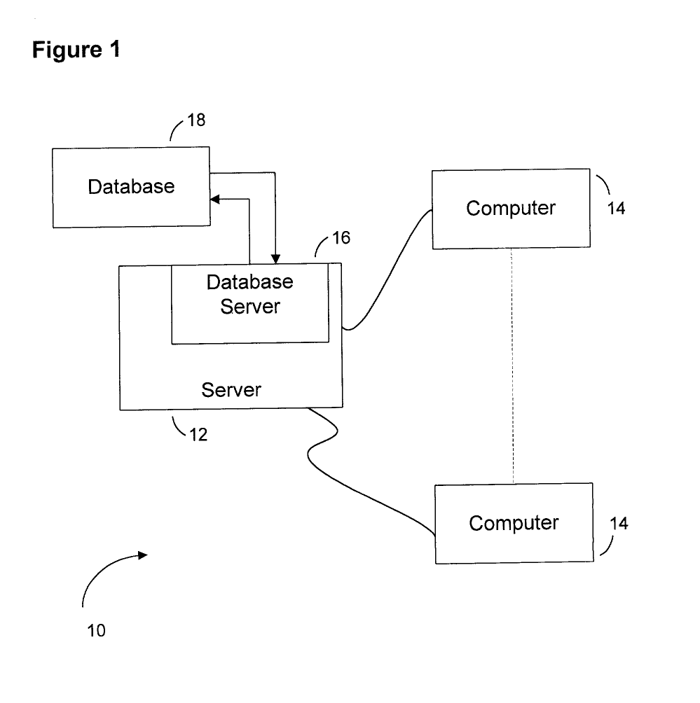

FIG. 1 is a block diagram of a system 10 in accordance with one embodiment of the present invention. System 10 includes a server sub-system 12, sometimes referred to herein as server 12, and a plurality of user devices 14 connected to server 12. In one embodiment, devices 14 are computers including a web browser, and server 12 is accessible to devices 14 via a network such as an intranet or the Internet. In an alternative embodiment, devices 14 are servers for a network of customer devices.

Devices 14 are interconnected to the network, such as a local area network (LAN) or a wide area network (WAN), through many interfaces including dial-in-connections, cable modems and high-speed ISDN lines. Alternatively, devices 14 are any device capable of interconnecting to a network including a network-based phone or other network-based connectable equipment. Server 12 includes a database server 16 connected to a centralized database 18 containing instrument transformer information. In one embodiment, centralized database 18 is stored on database server 16 and can be accessed by potential users at one of user devices 14 by logging onto server sub-system 12 through one of user devices 14. In an alternative embodiment centralized database 18 is stored remotely from server 12.

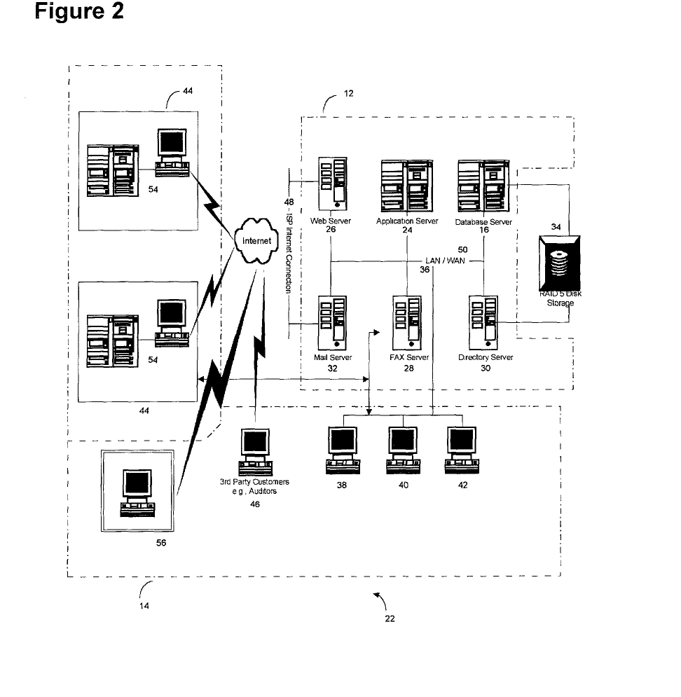

FIG. 2 is an expanded version block diagram of an exemplary embodiment of a server architecture of a system 22. System 22 includes server sub-system 12 and user devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server sub-system 12 is configured to be communicatively coupled to various individuals or employees 44 and to third parties, e.g., users, 46 via an ISP Internet connection 48. The communication in the exemplary embodiment is illustrated as being performed via the Internet, however, any other wide area network (WAN) type communication can be used in other embodiments, i.e., the systems and processes are not limited to being practiced via the Internet. In addition, and rather than a WAN 50, local area network 36 could be used in place of WAN 50.

In the exemplary embodiment, any employee 44 or user 46 having a workstation 54 can access server sub-system 12. One of user devices 14 includes a workstation 54 located at a remote location. Workstations 54 are personal computers having a web browser. Also, workstations 54 are configured to communicate with server sub-system 12. Furthermore, fax server 28 communicates with employees 44 and users 46 located outside the business entity and any of the remotely located user systems, including a user system 56 via a telephone link. Fax server 28 is configured to communicate with other workstations 38, 40, and 42 as well.

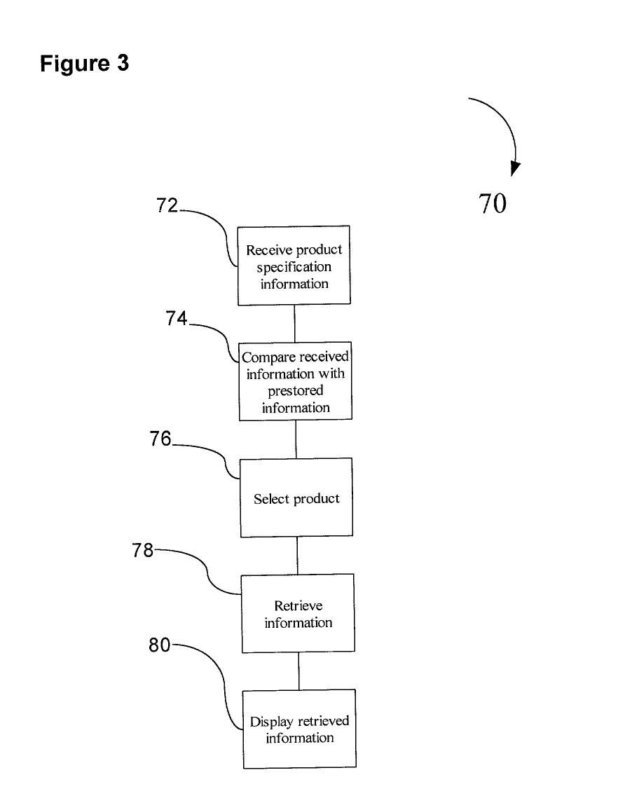

FIG. 3 is a flow diagram 70 for a network-based method for configuring instrument transformers. In one embodiment, the instrument transformer selection involves selection of instrument transformers. System 10 (shown in FIG. 1) receives 72 product specification information from a user. In one embodiment, the user inputs the information into a device (such as device 14 shown in FIG. 1) that transmits the information to a server (such as server 12 shown in FIG. 1). The product specification information is received from the user via a graphical user interface as will be described in greater detail below.

Server 12 compares 74 the received instrument transformer related requirements to pre-stored information accessible by server 12. In one embodiment, the pre-stored information is stored in a database that resides on server 12. In an alternative embodiment, the pre-stored information is stored in a database remote from server 12. The pre-stored information includes various types and configurations of instrument transformer related information. Server 12 compares the user provided information to the pre-stored information to determine if any pre-stored instrument transformer information contained in the database satisfy the product specifications/requirements submitted by the user.

In addition, server system 12 assesses the information supplied by the user to validate configuration compatibility of the product. Exemplary information includes product application, product parameters, desired product features, and product accessories. System 10 evaluates the information supplied by the user and determines whether a resulting product incorporating an instrument transformer having the received product specifications is capable of meeting parameters of the indicated product. For example, system 10 determines whether a selected instrument transformer with a given requirement is available to satisfy the user, and, if the selected instrument transformer with a given requirement is not available, system 10 displays a message to the user that the instrument transformer with the required product characteristics is not available and that the user should select an alternative product. In summary, system 10 reviews the user input and based on a pre-determined instrument transformer configuration as well as operating specifications, the user is provided feedback for a specific instrument transformer that meets the criteria for the user application.

If the product resulting from the received information does not meet the parameters of the product, system 10 guides a user by providing suggestions for a correct product configuration. In an alternative embodiment, system 10 guides a user by providing information regarding alternative products compatible with the product parameters supplied by the user. In a further alternative embodiment, system 10 guides a user by providing information regarding products that are upgrades for the product parameters supplied by the user.

System 10 then identifies pre-stored instrument transformer information that matches the information entered by the user and selects 76 instrument transformer configurations from the pre-stored information. System 10 retrieves 78 information pertaining to the selected instrument transformer configuration. In one embodiment, the instrument transformer information includes an instrument transformer identifier number and associated price for each selected instrument transformer configuration. For example, the instrument transformer identifier number is a catalog number and the price is a list price of the product. Server 12 then transmits the retrieved identifier number and associated price and downloads the retrieved instrument transformer information to user device 14 for display 80 so that the user can view the information. In an alternative embodiment, system 10 uses the list price information to generate a quotation for each selected instrument transformer configuration including the indicated features and accessories and server 12 then transmits the retrieved instrument transformer identifier number and the quotation to user device 14.

System 10 then prompts the user to order one or more of the selected products. If the user is a registered user, system 10 accepts orders online by providing the user a purchase order form and receiving the completed purchase order form from the user. The completed purchase order form is then authenticated against pre-determined criteria to determine whether system 10 should accept the completed purchase order form. If the purchase order form is accepted, the ordered product is then shipped to the user.

If the user is an unregistered user, and the user attempts to order a selected product, system 10 transmits a notification to the user indicating that a sales person or an authorized distributor will contact the user to confirm the order request. System 10 then transmits a notification, such as via email, to a selected person. The selected person then checks the order and instructs system 10 to transmit the order to a field sales regional manager or district manager. The field sales manager then follows-up with the lead or forwards the lead to a distributor with instructions to follow-up with the user that submitted the order.

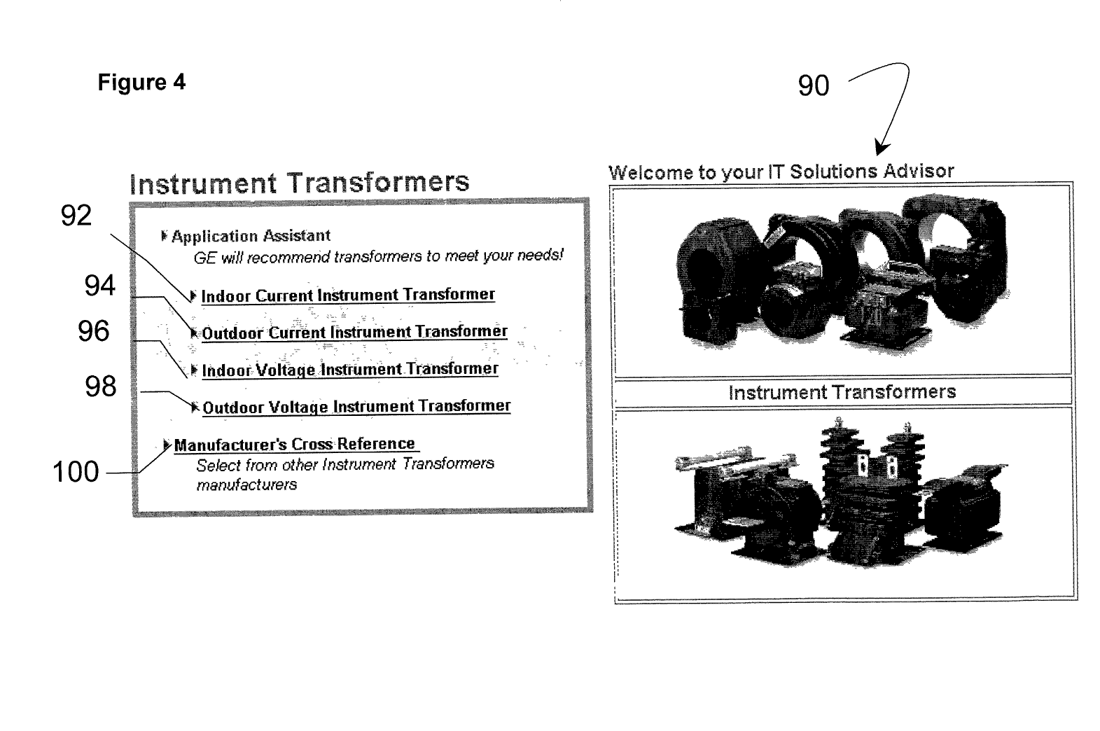

FIG. 4 shows an exemplary embodiment of an instrument transformer—main page, as depicted in screen shot 90. Screen shot 90 includes an Indoor Current Instrument Transformer link 92, an Outdoor Current Instrument Transformer link 94, an Indoor Voltage Instrument Transformer link 96, an Outdoor Voltage Instrument Transformer link 98, and a Manufacturer's Cross Reference link 100.

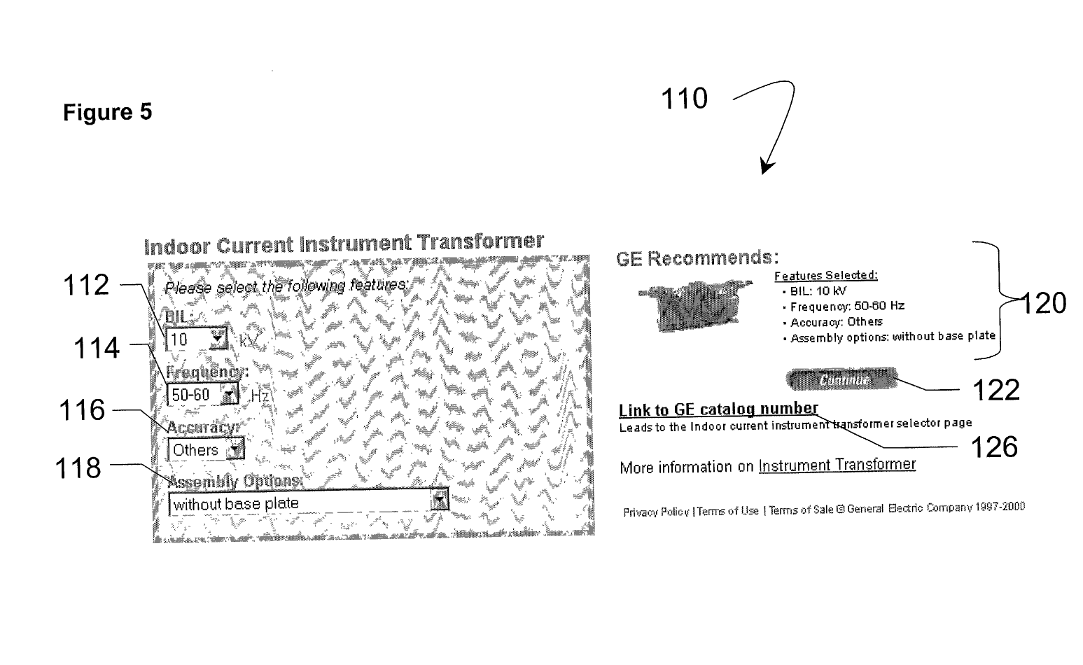

FIG. 5 shows an exemplary embodiment of an indoor current instrument transformer—application information page, as depicted in screen shot 110. Screen shot 110 includes a BIL pull down menu 112, a Frequency pull down menu 114, an Accuracy pull down menu 116, and an Assembly Options pull down menu 118. Screen shot 110 includes a recommendation display area 120, a Continue link 122, and a Link to GE Catalog Number link 126.

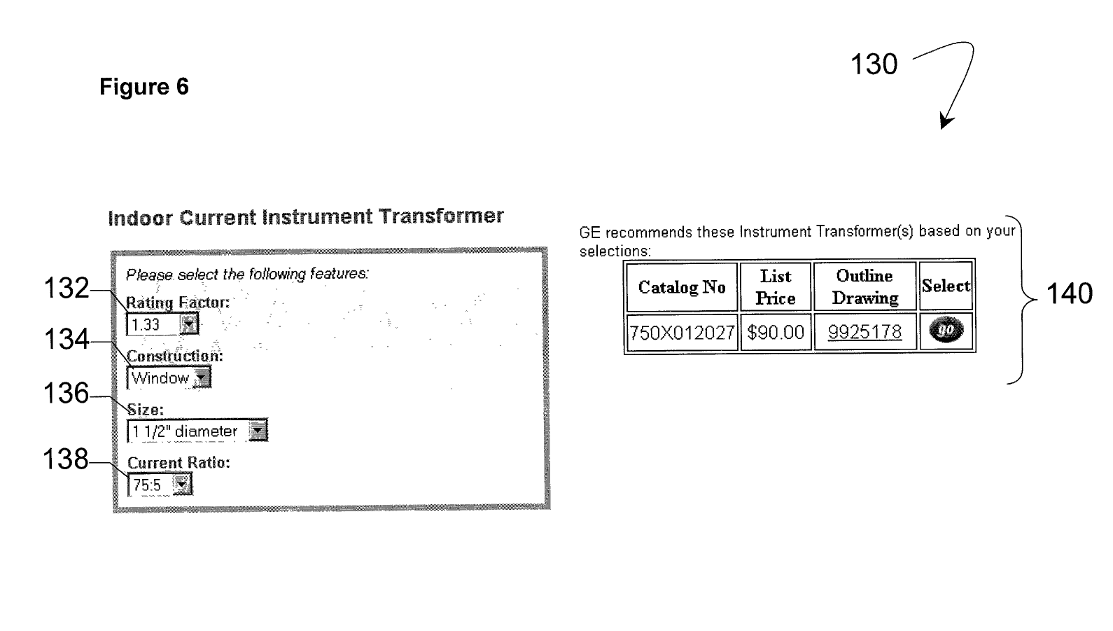

FIG. 6 shows an exemplary embodiment of an indoor current instrument transformer—application information page, as depicted in screen shot 130. Screen shot 130 includes a Rating Factor pull down menu 132, a Construction pull down menu 134, a Size pull down menu 136, and a Current Ratio pull down menu 138. Screen shot 130 also includes a recommendation area 140 that in one embodiment includes a catalog number, a list price, and an outline drawing of a recommended product, as well as a Select Go link to add a product to the bill of material.

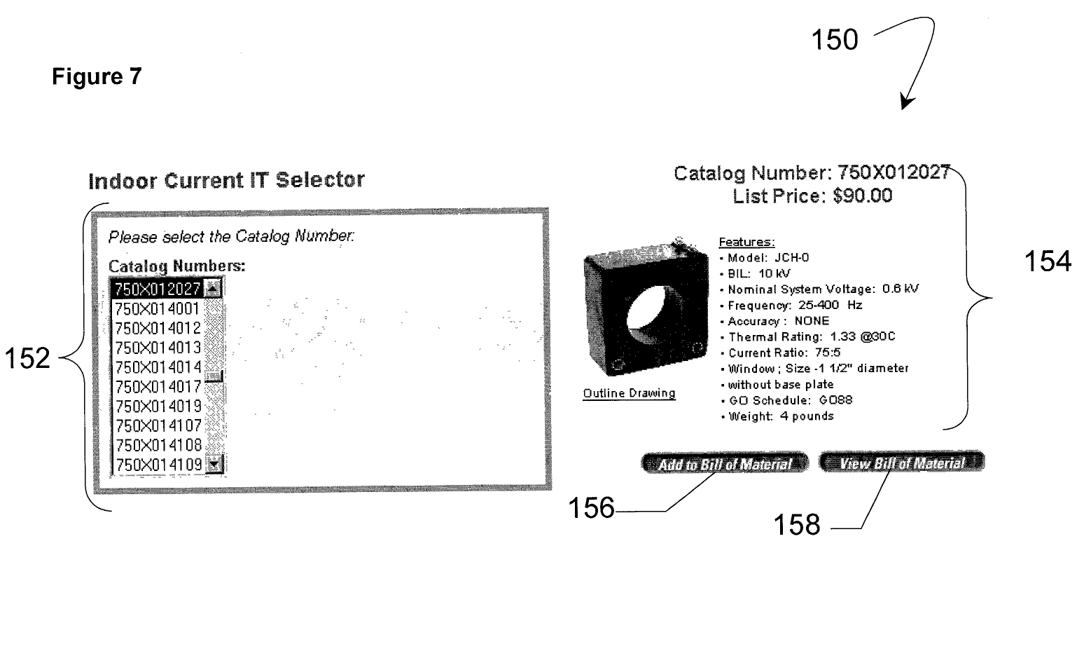

FIG. 7 shows an exemplary embodiment of an indoor current instrument transformer—selector page, as depicted in screen shot 150. Screen shot 150 includes a Catalog Numbers pull down menu 152, a recommendation display area 154 that in one embodiment includes a catalog number and a list price for a recommended product, an Add to Bill of Material button 156, and a View Bill of Material button 158.

Selection of Add to Bill of Material button 156 adds the selected item to the bill of material. View Bill of Material button 158 causes system 10 (shown in FIG. 1) to display a Bill of Material page, discussed below.

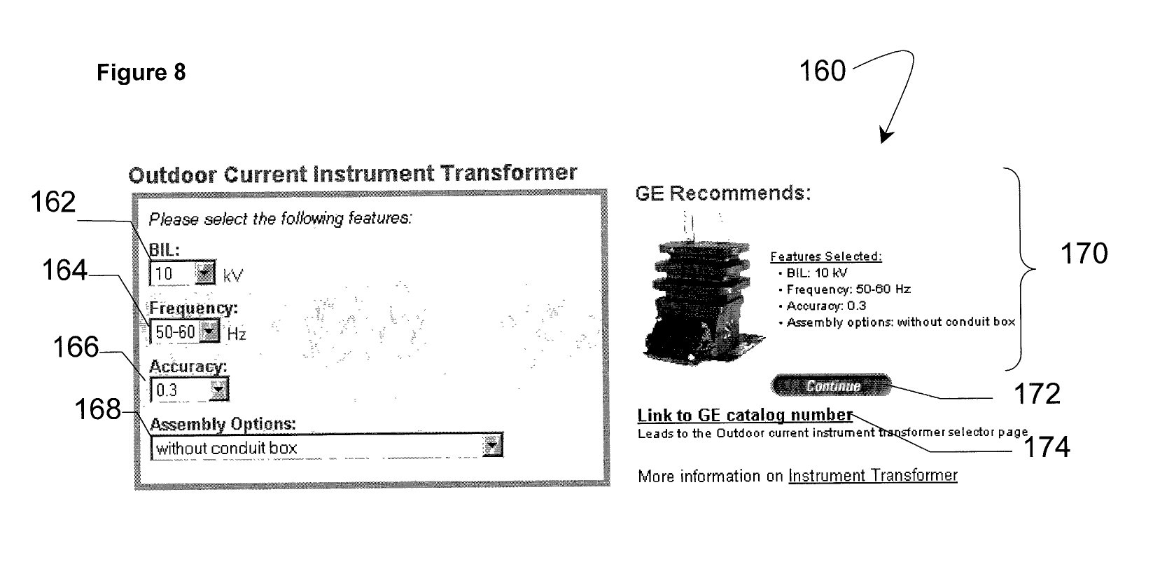

FIG. 8 shows an exemplary embodiment of an outdoor current instrument transformer—application information page, as depicted in screen shot 160. Screen shot 160 includes a BIL pull down menu 162, a Frequency pull down menu 164, an Accuracy pull down menu 166, and an Assembly Options pull down menu 168. Screen shot 160 also includes a recommendation area 170 that specifies further information about the recommended product. Screen shot 160 further includes a Continue button 172, and a Link to GE catalog Number link 174.

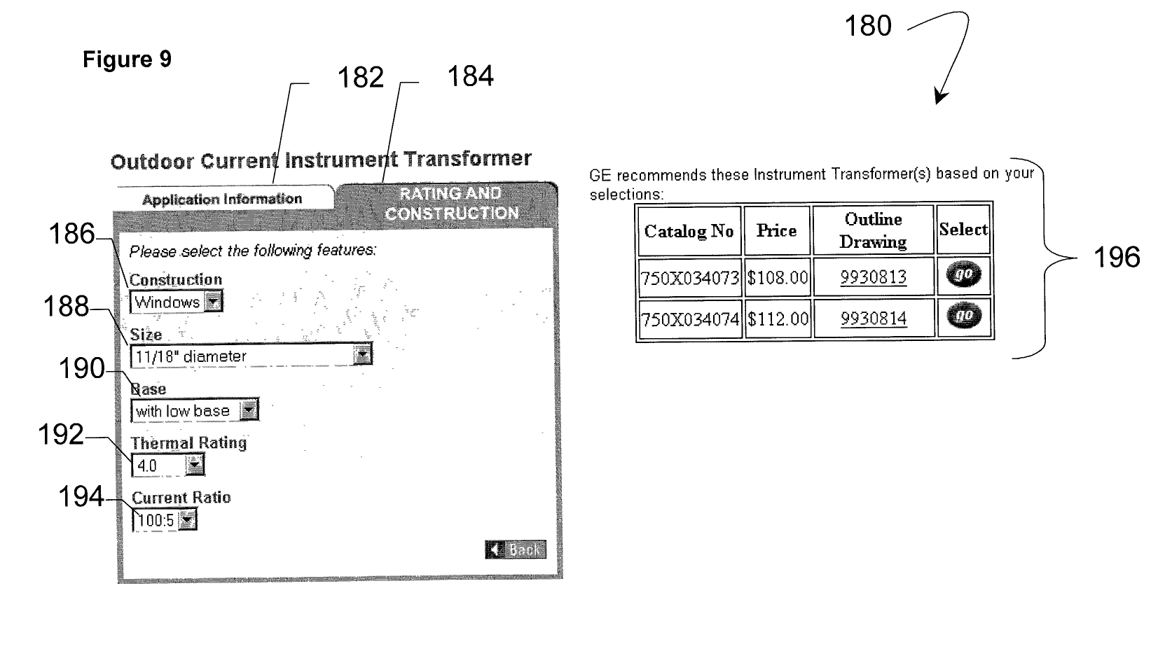

FIG. 9 is an exemplary embodiment of an outdoor current instrument transformer—rating and construction page, as depicted in screen shot 180. Screen shot 180 includes an Application Information tab 182 and a Rating and Construction tab 184; screen shot 180 results from selection of Rating and Construction tab 184. Screen shot 180 includes a Construction pull down menu 186, a Size pull down menu 188, a Base pull down menu 190, a Thermal Rating pull down menu 192, and a Current Ratio pull down menu 194. Screen shot 180 also includes a recommendation display area 196 that in one embodiment includes a catalog number, a list price, and an outline drawing for a recommended product, as well as a Select Go link to add a product to the bill of material.

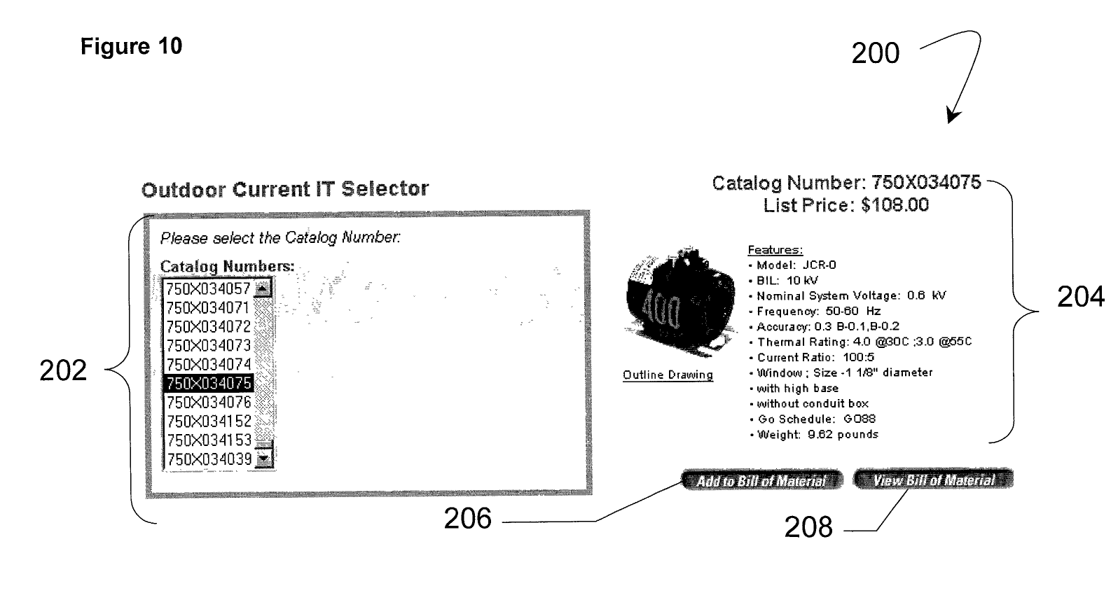

FIG. 10 is an exemplary embodiment of an outdoor current instrument transformer—Selector page, as depicted in screen shot 200. Screen shot 200 includes an Catalog Numbers pull down menu 202 and a recommendation display area 204 that in one embodiment includes a catalog number, a list price, and an outline drawing for a recommended product. Screen shot 200 also includes an Add to Bill of Material radio button 206 and a View Bill of Material radio button 208.

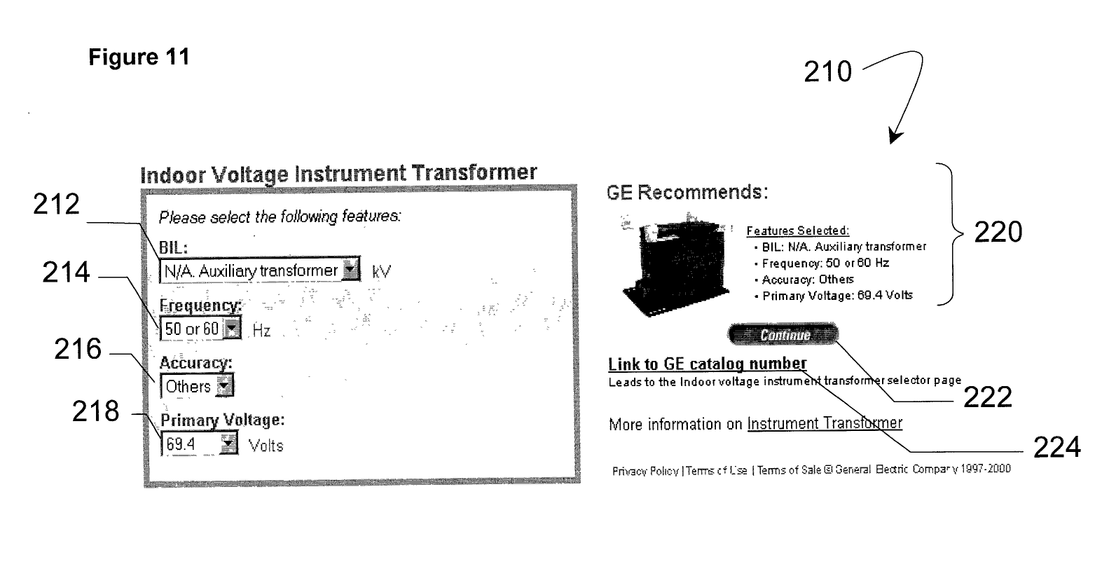

FIG. 11 is an exemplary embodiment of an indoor voltage instrument transformer—application information page, as depicted in screen shot 210. Screen shot 210 includes a BIL pull down menu 212, a Frequency pull down menu 214, an Accuracy pull down menu 216, and a Primary Voltage pull down menu 218. Screen shot 210 also includes a recommendation display area 220 for a recommended product. Screen shot 210 also includes a Continue button 222 and a Link to GE Catalog Number link 224.

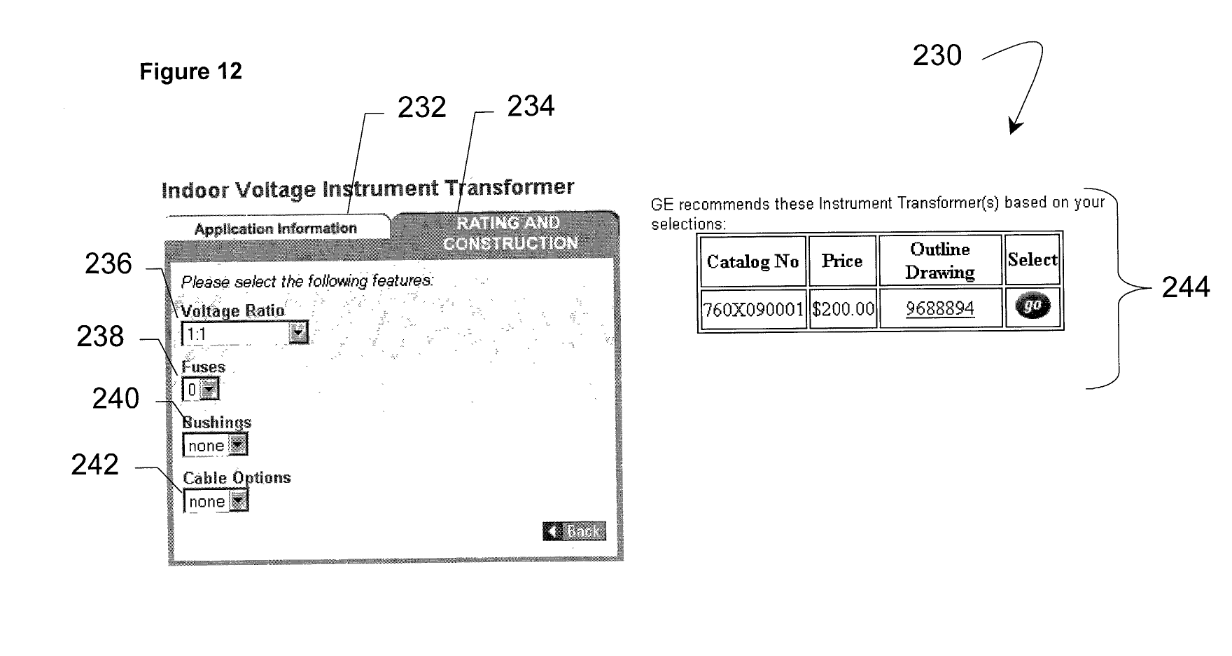

FIG. 12 is an exemplary embodiment of an indoor voltage instrument transformer—rating and construction page, as depicted in screen shot 230. Screen shot 230 includes an Application Information tab 232 and a Rating and Construction tab 234; screen shot 230 results from selection of Rating and Construction tab 234. Screen shot 230 includes a Voltage Ratio pull down menu 236, a Fuses pull down menu 238, a Bushings pull down menu 240, and a Cable Options pull down menu 242. Screen shot 230 also includes a recommendation display area 244 that in one embodiment includes a catalog number, a list price, and an outline drawing for a recommended product, as well as a Select Go link to add a product to the bill of material.

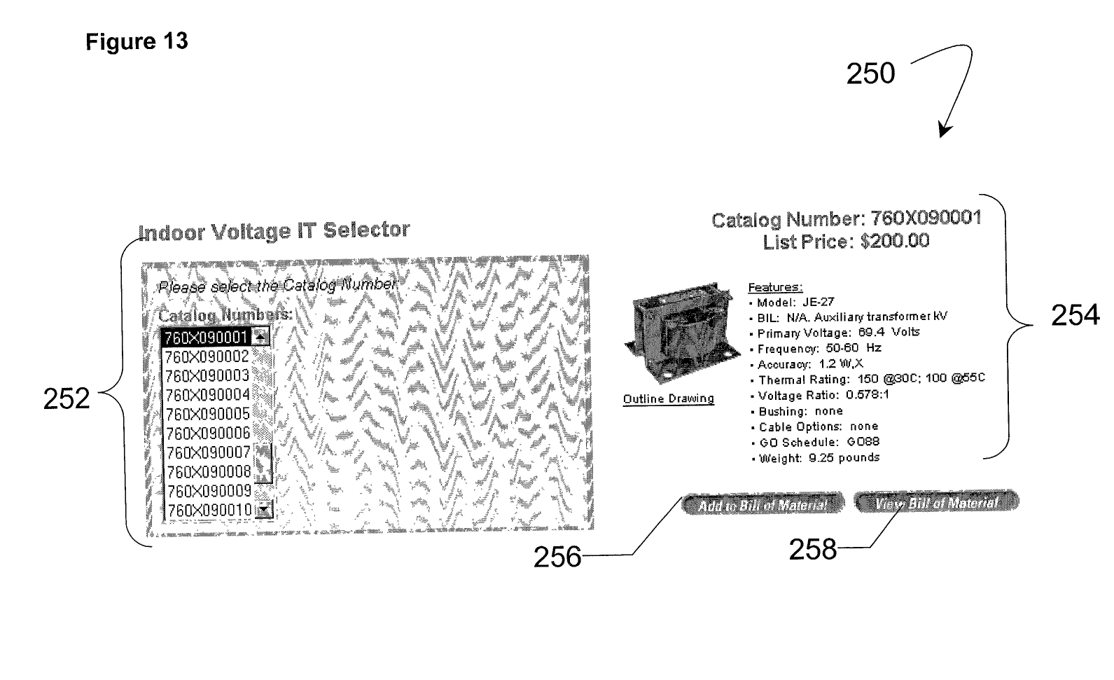

FIG. 13 is an exemplary embodiment of an indoor voltage instrument transformer—selector page, as depicted in screen shot 250. Screen shot 250 includes a Catalog Numbers pull down menu 252, and a recommendation display area 254 that in one embodiment includes a catalog number, a list price, and an outline drawing for a recommended product. Screen shot 250 also includes an Add to Bill of Material radio button 256 and a View Bill of Material radio button 258.

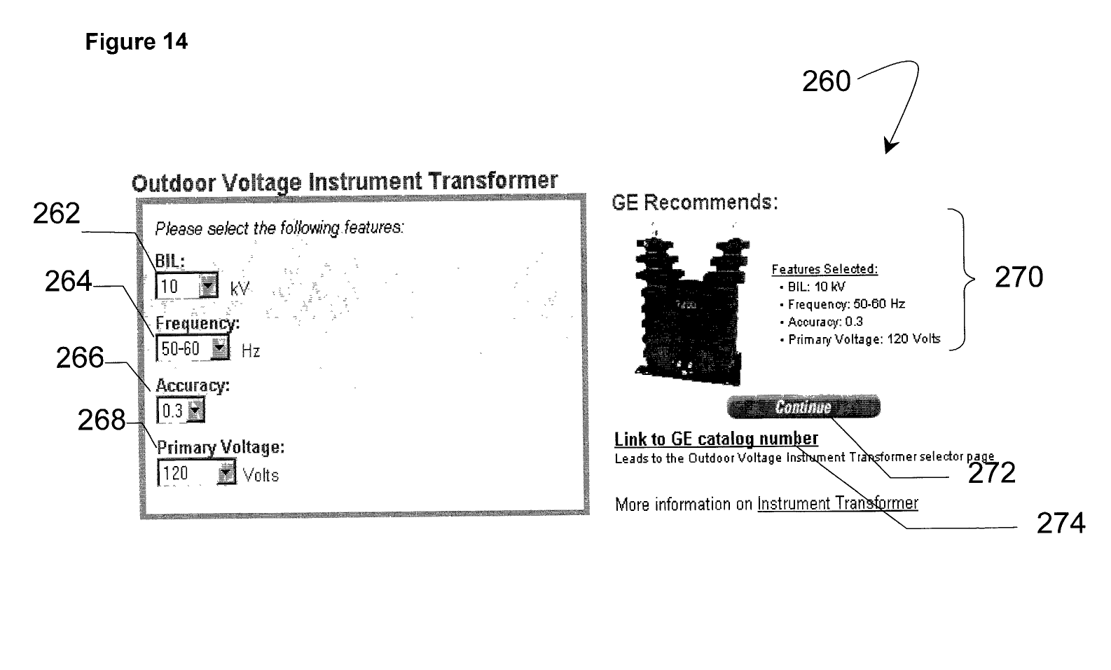

FIG. 14 shows an exemplary embodiment of an outdoor voltage instrument transformer—application information page, as depicted in screen shot 260. Screen shot 260 includes a BIL pull down menu 262, a Frequency pull down menu 264, an Accuracy pull down menu 266, and a Primary Voltage pull down menu 268. Screen shot 260 also includes a recommendation area 270 that specifies further information about the recommended product. Screen shot 260 further includes a Continue button 272, and a Link to GE catalog Number link 274.

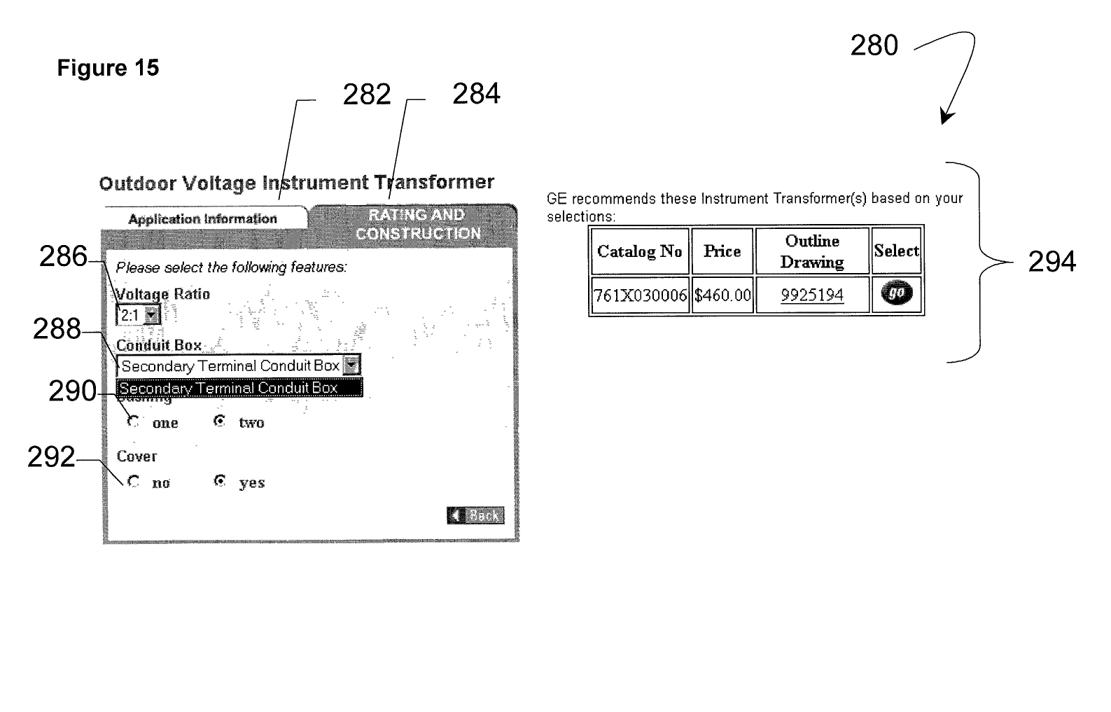

FIG. 15 is an exemplary embodiment of an outdoor voltage instrument transformer—rating and construction page, as depicted in screen shot 280. Screen shot 280 includes an Application Information tab 282 and a Rating and Construction tab 284. Screen shot 280 results from selection of Rating and Construction tab 284. Screen shot 280 includes a Voltage Ratio pull down menu 286, a Conduit Box pull down menu 288, a Bushing pull down menu 290, and a Cover pull down menu 292. Screen shot 280 also includes a recommendation display area 294 that in one embodiment includes a catalog number, a list price, and an outline drawing for a recommended product, as well as a Select Go link to add a product to the bill of material.

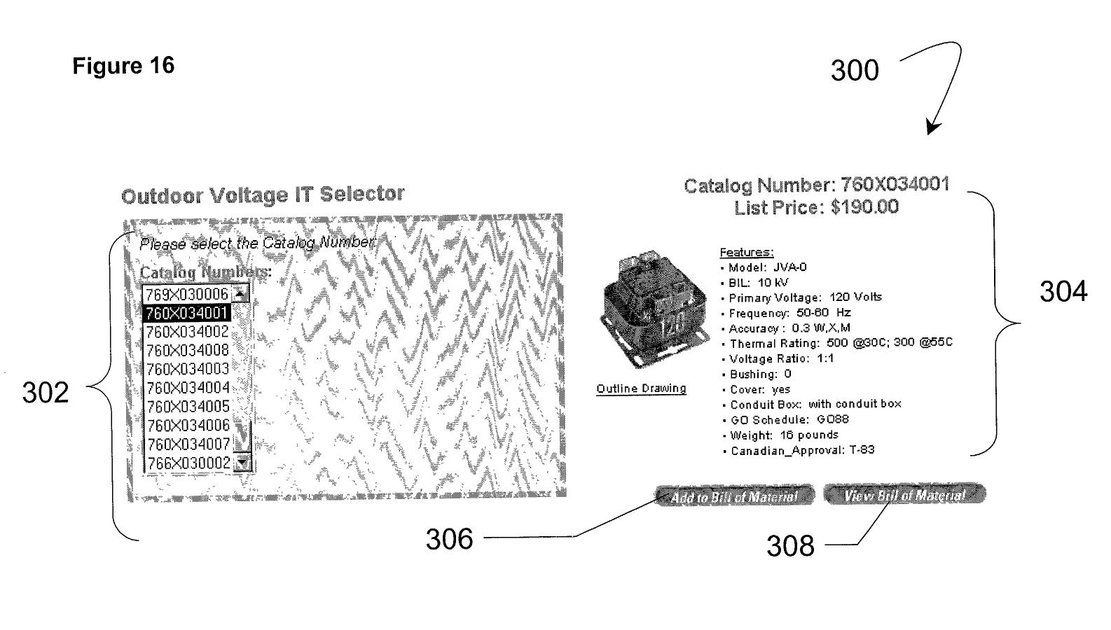

FIG. 16 is an exemplary embodiment of an outdoor voltage instrument transformer—selector page, as depicted in screen shot 300. Screen shot 300 includes a Catalog Numbers pull down menu 302 and a recommendation display area 304 that in one embodiment includes a catalog number, a list price, and an outline drawing for a recommended product. Screen shot 300 also includes an Add to Bill of Material radio button 306 and a View Bill of Material radio button 308.

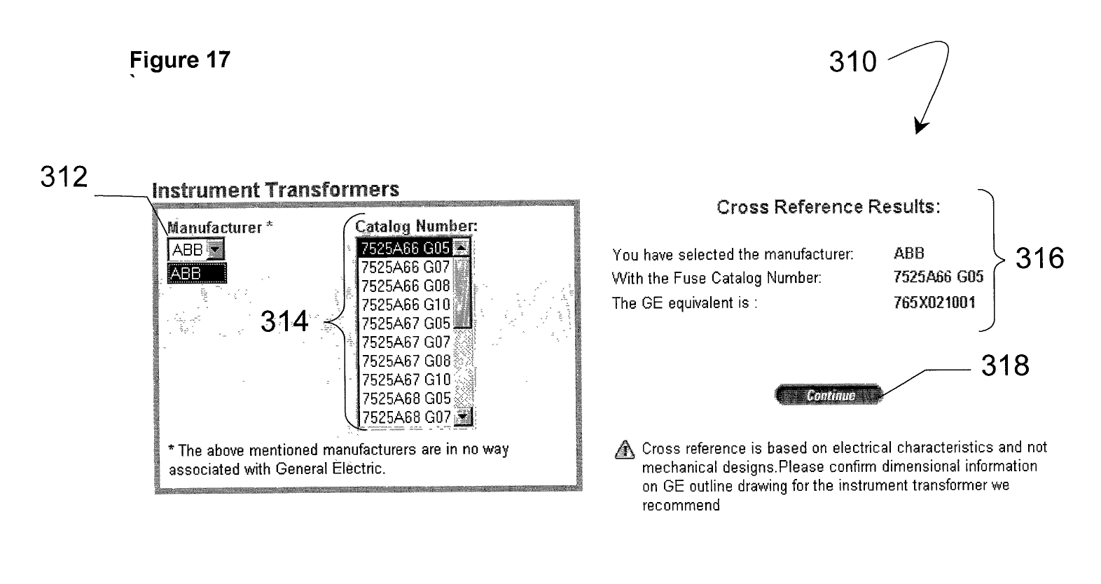

FIG. 17 is an exemplary embodiment of an instrument transformer—cross reference page, as depicted in screen shot 310. Screen shot 310 includes a Manufacturer pull down menu 312 and a Catalog Number pull down menu 314. Screen shot 310 also includes a cross references results display area 316 that in one embodiment includes a manufacturer, a catalog number, and a GE equivalent product, as well as a Continue button 318.

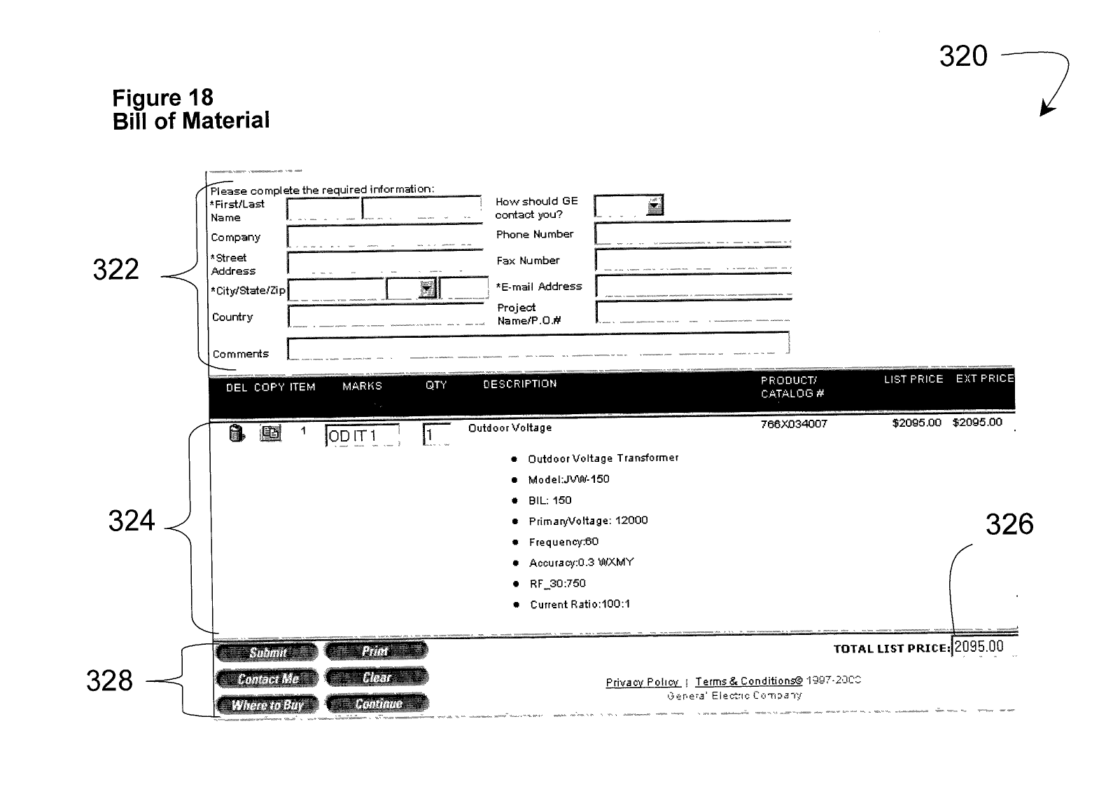

FIG. 18 is an exemplary embodiment of a Bill of Material page, as depicted in screen shot 320, that is downloaded and displayed by server system 12 when the user has selected a “View Bill of Material” button. Screen shot 320 includes a customer information area 322 where a user can specify contact information. Screen shot 320 also includes an order area 324 to display information about the order, including in one embodiment a specification of an item ordered, the quantity, description, catalog number, and price. Screen shot 320 further includes a List Price text box 326 that displays a total price of all items ordered. Screen shot 320 still further includes a set of buttons 328 that allow the user to submit the order, print the order, clear the bill of material, request that the user be contacted, find out where to buy the product, or continue.

In use, system 10 (shown in FIG. 1) provides the user with a complete instrument transformer configured to meet the user's needs. The user selects the rating of the instrument transformer, including power system rating, voltage rating, design requirements, number of poles, application, enclosure type, and any optional features. Based on these inputs system 10 displays the individual equipment prices and the total list price of the individual components. System 10 does not allow the user to configure a selection that is invalid and guides the user by informing the user why the selected configuration is invalid. Once the customer has configured the product, the user can add it to the user's bill of materials and then view the bill of materials, which the user can optionally print, or submit as an order.

While the invention has been described in terms of various specific embodiments, those skilled in the art will recognize that the invention can be practiced with modification within the spirit and scope of the claims.

What is claimed is:

1. A method for facilitating selection of an instrument transformer through use of a network-based system including a server and at least one device connected to the server via a network, said method comprising the steps of:
receiving product specification information from a user via the device;
comparing the received product specification information with pre-stored instrument transformer information;
selecting at least one instrument transformer that matches the received product specification information; and
displaying the information related to the instrument transformer.

2. A method according to claim 1 wherein said step of comparing the received product specification information comprises the steps of:
determining whether the features selected are available for the selected instrument transformer configuration; and
displaying a message if the selected features are not available for the selected instrument transformer configuration.

3. A method according to claim 1 wherein said step of receiving product information data from a user further comprises the step of receiving an identification for the product.

4. A method according to claim 1 wherein said step of displaying information related to the instrument transformer comprises the step of displaying the features selected for the instrument transformer.

5. A method according to claim 1 wherein said step of displaying information related to the instrument transformer comprises the step of displaying the accessories selected for the instrument transformer.

6. A method according to claim 1 wherein said step of displaying information related to the instrument transformer comprises the step of displaying a catalog number and a list price for the instrument transformer.

7. A method according to claim 1 wherein said step of displaying information further comprises the step of generating a quotation for the instrument transformer.

8. A method according to claim 1 wherein said step of displaying information related to the instrument transformer comprises the step of displaying the dimensions of the instrument transformer.

9. A method according to claim 1 wherein the product specification information is received from the user via a graphical user interface.

10. A method according to claim I further comprising the step of assessing a need of the user based on at least one of a product application, product parameters, desired product features, and product accessories.

11. A method according to claim 1 further comprising the step of validating configuration compatibility based on the received product specification information to determine whether a resulting instrument transformer having the received product specifications is capable of meeting parameters of the product.

12. A method according to claim 11 further comprising the step of guiding the user, if the resulting product does not meet the parameters of the product, to a correct product configuration.

13. A method according to claim 11 further comprising the step of guiding the user to a compatible product.

14. A system for facilitating selection of an instrument transformer, said system comprising:
a device; and
a server connected to said device and configured to receive product specification information data from a user via said device, said server further configured to:
compare the received product specification information with pre-stored instrument transformer information;
select at least one instrument transformer from the pre-stored instrument transformer information based on instrument transformer identification criteria entered by the user; and
display information related to the instrument transformer based on the instrument transformer identification criteria.

15. A system according to claim 14 wherein said server further configured to download to the user the information related to the instrument transformer.

16. A system according to claim 14 wherein said server further configured to:
determine whether the features selected are available for the selected instrument transformer configuration; and
display a message if the selected features are not available for the selected instrument transformer configuration.

17. A system according to claim 14 wherein said server further configured to receive an identification for the product.

18. A system according to claim 14 wherein said server further configured to display the dimensions of the instrument transformer.

19. A system according to claim 14 wherein said server further configured to display the accessories selected for the instrument transformer.

20. A system according to claim 14 wherein said server further configured to:
determine whether the features selected are available for the selected instrument transformer configuration; and
display a message if the selected features are not available for the selected instrument transformer configuration.

21. A system according to claim 14 wherein said server further configured to receive an identification for the product.

22. A system according to claim 14 wherein said server further configured to display the features selected for the instrument transformer.

23. A system according to claim 14 wherein said server further configured to display the dimensions of the instrument transformer.

24. A system according to claim 14 wherein said server further configured to display the accessories selected for the instrument transformer.

25. A system according to claim 14 wherein said server further configured to display a catalog number and a list price for the instrument transformer.

26. A system according to claim 14 wherein said server further configured to generate a quotation for the instrument transformer.

27. A system according to claim 14 wherein said server further configured to receive the product specification information from the user via a graphical user interface.

28. A system according to claim 14 wherein said server further configured to assess a need of the user based on at least one of a product application, product parameters, desired product features, and product accessories.

29. A system according to claim 28 wherein said server further configured to validate configuration compatibility based on the received product specification information to determine whether a resulting instrument transformer having the received product specifications is capable of meeting parameters of the product.

30. A system according to claim 29 wherein said server further configured to guide the user, if the resulting product does not meet the parameters of the product, to a correct product configuration.

31. A system according to claim 30 wherein said server further configured to guide the user to a compatible product.

32. A system according to claim 14 wherein said server further configured to accept a purchase order for the instrument transformer after the purchase order has been authenticated against pre-determined criteria.

33. A system according to claim 14 wherein said device configured to be a server for a network of customer devices.

34. A system according to claim 14 wherein said server and said device are connected via a network.

35. A system according to claim 34 wherein said network is one of a wide area network, a local area network and the Internet.
